(19) United States
(12) Patent Application Publication
(10) Pub. No.: US 2012/0013938 A1
(43) Pub. Date: Jan. 19, 2012

(54) IMAGE PROCESSING DEVICE, HARDWARE ACCELERATOR, AND IMAGE PROCESSING METHOD

(76) Inventors: Hiroshi Nogawa, Tokyo (JP); Fumihito Akiyama, Yokohama-shi (JP); Masahiro Ozawa, Tokyo (JP); Jun Kuroki, Superior, CO (US); Takahisa Matsunaga, Tokyo (JP); Yasufumi Aoyama, Tokyo (JP); Kunikazu Satou, Tokyo (JP)

(21) Appl. No.: 12/836,210

(22) Filed: Jul. 14, 2010

(51) Int. Cl. G06F 3/12

(52) U.S. Cl. 358/1.15

(57) ABSTRACT

Disclosed is an image processing device to generate printing data based on intermediate language data, comprising: a memory to store the intermediate language data and the printing data; a hardware accelerator to perform rendering processing to generate the printing data from the intermediate language data read from the memory; and a control section to input a memory address of the intermediate language data stored in the memory to the hardware accelerator, wherein at least one of the hardware accelerator and the control section obtains a plurality of rendering regions corresponding to ranges to which the rendering processing is performed based on the intermediate language data, and produces a comprehensive rendering region comprehending the rendering regions based on a correlation between the plurality of rendering regions, and wherein the hardware accelerator generates the printing data corresponding to the comprehensive rendering region to transfer the generated printing data to the memory.

### BACKGROUND OF THE INVENTION

1. Field of the Invention

The present invention relates to an image processing device, a hardware accelerator, and an image processing method.

2. Description of the Related Art

In recent years, a further price-reduction of an image forming apparatus, such as a multi function peripheral (MFP) and a printer, has been required. Thereby, there has been necessity of developments directed to products placing more emphasis on lowering the cost thereof. As a technique for suppressing the cost to be lowered, one may adopt a less expensive central processing unit (CPU) to be mounted on an image forming apparatus. However, such a less expensive CPU tends to have lower computing performance. Accordingly, the performance degradation in the image forming apparatus, such as the slowdown of the operation thereof would occur, owing to the reduction in the processing speed of the CPU, when simply using such a less expensive CPU.

As such, methods of reducing the load of a CPU have been devised. As one of the methods of reducing the load of a CPU, for example, there is a technique of achieving the reduction in a computing quantity and the reduction in a memory consumption quantity, through producing a polygonal region by collecting a predetermined number of adjacent rectangular regions having the same color and density in the processing (rasterization processing) where printing data is generated from intermediate language data (see, for example, Japanese Patent Application Laid-Open Publication No. 2002-15330).

The technique described in Japanese Patent Application Laid-Open Publication No. 2002-15330, however, could not sufficiently reduce the load of a CPU. The reason is that, because the production of a polygonal region for reducing an computing quantity is performed under the condition in which the predetermined number of adjacent rectangular regions having the same color and density do exist, it would be impossible to reduce the load of the rasterization processing when such a condition is not satisfied.

On the other hand, as another method of reducing the load of a CPU, a method of realizing the speeding-up of processing by imposing a part of the image processing, such as rasterization processing, on dedicated hardware (which is hereinafter referred to as “hardware accelerator”) to reduce the processing load of the CPU, has been devised.

However, the speeding-up of processing and the reduction of cost cannot be realized merely by simply replacing the processing performed by the CPU using software with the processing by the hardware accelerator.

The reason why the speeding-up of processing cannot be realized is that, because the input and output of a large quantity of data are performed between a memory of an image forming apparatus and a local memory in the hardware accelerator at the time of performing image processing, the data transfer quantity between the memory of the image forming apparatus and the local memory in the hardware accelerator increases, and the time required for the data transfer is increased, thereby the processing speed is decreased.

The reason why the reduction of cost cannot be achieved is that the local memory in the hardware accelerator requires a large capacity in order to perform the input and output of a large quantity of data between the memory of the image forming apparatus and the local memory in the hardware accelerator. The hardware accelerator including the local memory with a large capacity is expensive, which would balance out the reduction of the cost expected by using a hardware accelerator.

### SUMMARY OF THE INVENTION

The present invention was made in consideration of the resources situation mentioned above, and aims to realize image processing capable of coping with the cost reduction and the speeding-up of processing at the same time.

To achieve at least one of the abovementioned objects, an image processing device to generate printing data based on intermediate language data, reflecting one aspect of the present invention comprises:

a memory to store the intermediate language data and the printing data;

a hardware accelerator to perform rendering processing to generate the printing data from the intermediate language data read from the memory;

and

a control section to input a memory address of the intermediate language data stored in the memory to the hardware accelerator,

wherein at least one of the hardware accelerator and the control section obtains a plurality of rendering regions corresponding to ranges to which the rendering processing is performed based on the intermediate language data, and produces a comprehensive rendering region comprehending the plurality of rendering regions based on a correlation between the plurality of rendering regions,

and wherein the hardware accelerator generates the printing data corresponding to the comprehensive rendering region to transfer the generated printing data to the memory.

Preferably, at least one of the hardware accelerator and the control section integrates the plurality of rendering regions, a part or a whole of which overlaps with each other.

Preferably, at least one of the hardware accelerator and the control section produces the comprehensive rendering region based on an existence of a split between the plurality of rendering regions.

Preferably, only the hardware accelerator performs processing of obtaining the rendering regions showing the ranges to which the rendering processing is performed based on the intermediate language data, and producing the comprehensive rendering region based on the correlation between the plurality of rendering regions.

Preferably, the rendering regions are respectively a rectangular region including a minimum requisite range to perform the rendering processing.

Preferably, the rendering processing by the hardware accelerator is performed by a plurality of lines.

Preferably, the rendering processing by the hardware accelerator is performed by each line.

### BRIEF DESCRIPTION OF THE DRAWINGS

The present invention will become more fully understood from the detailed description given hereinbelow and the appended drawings, and thus are not intended as a definition of the limits of the present invention, wherein;

FIG. 1 is a network configuration view including image forming apparatuses, each comprising an image processing device according to the present invention;

FIG. 2 is a block diagram showing a principal configuration of each computer;

FIG. 3 is a block diagram showing a principal configuration of each of the image forming apparatuses;

FIG. 4 is a functional block diagram showing an example of a process and a function of image processing performed by each of the image forming apparatus;

FIG. 5 is a conceptual explanatory view showing processing of copying a part corresponding to a rendering region F in DL data and printing data from a memory to a local memory by a hardware accelerator;

FIG. 6 is a conceptual explanatory view showing processing of rendering objects based on DL data by the hardware accelerator;

FIG. 7 is a conceptual explanatory view showing processing of reflecting the data in a rendering region output from the hardware accelerator to the printing data in the memory;

FIG. 8 is an explanatory view showing an example of rendering content for one band;

FIG. 9 is an explanatory view showing an example of a rendering region obtained based on DL data indicating the rendering content shown in FIG. 8;

FIG. 10 is a flow chart showing a flow of the processing of the hardware accelerator in rasterization processing; and

FIG. 11 is a flow chart showing a flow of the processing of obtaining optimum rendering regions, shown at Step S4 of FIG. 10.

### DETAILED DESCRIPTION OF THE PREFERRED EMBODIMENTS

In the following, an example of the embodiment of the present invention will be described in detail with reference to the accompanying drawings.

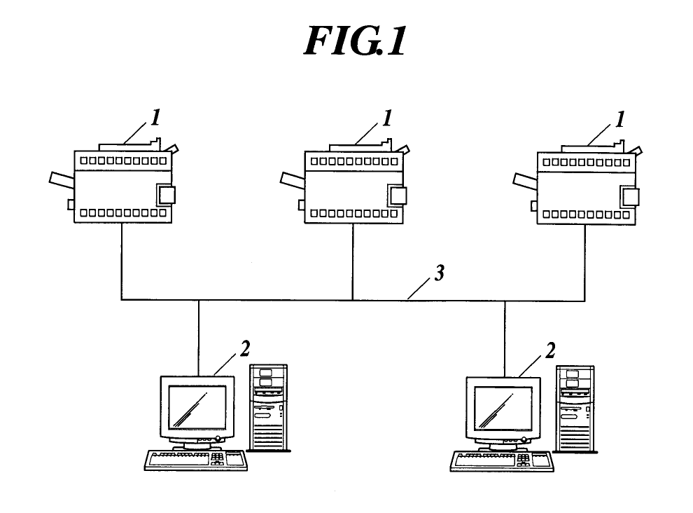

FIG. 1 is a network configuration view, including image forming apparatuses 1, 1, 1 each comprising an image processing device according to the present invention.

The image forming apparatuses 1, 1, 1 are connected to computers 2, 2 through a line 3 communicably.

The line 3 configures a network connecting the image forming apparatuses 1, 1, 1 and the computers 2, 2. The line 3 may take any form as long as the line 3 can connect the computers 2, 2 and the image forming apparatuses 1, 1, 1 communicably. For example, the line 3 may be any one of a wired connection line, such as Ethernet (registered trademark), a coaxial cable, and an optical fiber; and various standards for realizing wireless communication. Alternatively, a combination of a plurality of the above measures may be adopted. Furthermore, the line 3 may have any network scale of a local area network (LAN), the Internet, and the like.

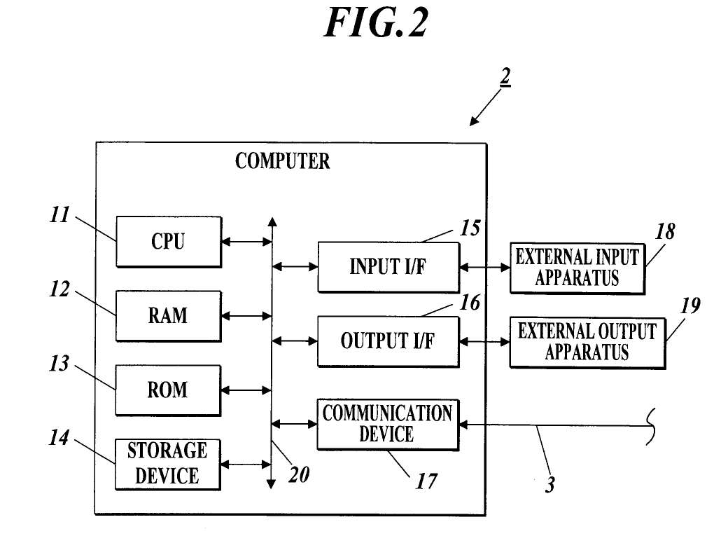

FIG. 2 is a block diagram showing the principal configuration of the computer 2.

The computers 2, 2 respectively include a central processing unit (CPU) 11, a random access memory (RAM) 12, a read only memory (ROM) 13, a storage device 14, an input interface (I/F) 15, an output I/F 16, and a communication device 17. The CPU 11, the RAM 12, the ROM 13, the storage device 14, the input I/F 15, the output I/F 16, and the communication device 17 are connected to one another through a bus 20.

The CPU 11 reads a program, data, and the like corresponding to processing content from the ROM 13 or the storage device 14 to process the read program, data, and the like. The CPU 11 thereby performs various kinds of processing of the computer 2 and the operation control of each section in the computer 2.

The RAM 12 functions as a primary storage device, storing the programs, data, and the like to be read in the processing executed by the CPU 11, and further storing the data, parameters, and the like generated by the processing.

The ROM 13 stores the programs, data, and the like read by the CPU 11 in a non-rewritable state.

The storage device 14 is, for example, a hard disk, a flash memory, or the like, and stores the programs, data, and the like read by the CPU 11 in a rewritable state.

The input I/F 15 is an interface for receiving an input by an input apparatus, such as an external input apparatus 18. The external input apparatus 18 comprises, for example, a keyboard, a mouse, and the like, and an input instruction is performed by a user's manual operation.

The output I/F 16 is an interface for performing output to an output apparatus, such as an external output apparatus 19. The external output apparatus 19 is, for example, a display apparatus, such as a cathode ray tube (CRT) and a liquid crystal display, and the external output apparatus 19 displays an output screen based on a processing result of the CPU 11.

The communication device 17 connects the computer 2 to an external communication line (for example, the line 3) to make the communication with external equipment possible. The communication device 17 is, for example, a network interface card (NIC), and a device enabling the connection thereof according to the type of the communication line can be used.

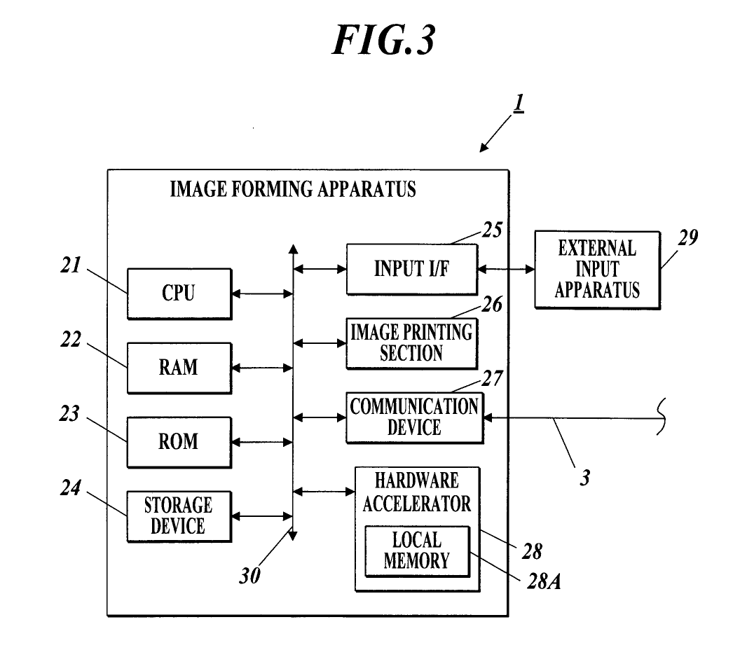

FIG. 3 is a block diagram showing the principal configuration of the image forming apparatus 1. Because the image forming apparatuses 1, 1, 1 shown in FIG. 1 all share the same configuration, a description is given for a single image forming apparatus 1 hereinafter.

The image forming apparatus 1 comprises a CPU 21, a RAM 22, a ROM 23, a storage device 24, an input I/F 25, an image printing section 26, a communication device 27, and a hardware accelerator 28. The CPU 21, the RAM 22, the ROM 23, the storage device 24, the input I/F 25, the image printing section 26, the communication device 27, and the hardware accelerator 28 are connected to one another through a bus 30.

The CPU 21 reads a program, data, and the like corresponding to processing content from the ROM 23 or the storage device 24 to process the read program, data, and the like. The CPU 21 thereby performs various kinds of processing of the image forming apparatus 1 and the operation control of each section in the image forming apparatus 1.

The RAM 22 functions as a primary storage device, storing the programs, data, and the like to be read in the processing executed by the CPU 21, and further storing the data, parameters, and the like generated by the processing.

The ROM 23 stores the programs, data, and the like read by the CPU 21 in a non-rewritable state.

The storage device 24 is, for example, a hard disk, a flash memory, or the like, and stores the programs, data, and the like read by the CPU 21 in a rewritable state.

The input I/F 25 is an interface for receiving an input by an input apparatus, such as an external input apparatus 29. The external input apparatus 29 may for example be an input panel, comprising a touch panel display, and an input instruction is performed by a user's manual operation.

The image printing section 26 is an engine for forming an image onto a printing medium, such as a sheet of paper, on the basis of printing data 62, which will be described later.

The communication device 27 connects the image forming apparatus 1 to an external communication line (for example, the line 3) to make the communication with external equipment possible. The communication device 27 is, for example, a network interface card (NIC), and a device enabling the connection thereof according to the type of the communication line can be used.

The hardware accelerator 28 is a digital signal processor (DSP) for performing rendering processing. The hardware accelerator 28 is, for example, an application specific integrated circuit (ASIC), and the hardware accelerator 28 of the present embodiment is dedicated hardware for performing rendering processing. The rendering processing performed by the hardware accelerator 28 will be described later.

The hardware accelerator 28 includes a local memory 28A. The hardware accelerator 28 performs processing by using a storage region of the local memory 28A, in data reading processing and rendering processing.

The hardware accelerator 28 is provided to the image forming apparatus 1 in a detachably attachable state. A single hardware accelerator 28 is shown in FIG. 3, but a plurality of hardware accelerators 28 may be provided to one image forming apparatus 1. When a plurality of hardware accelerators 28 is provided to one image forming apparatus 1, the plurality of hardware accelerators 28 can respectively take partial charge of processing.

Next, image processing by the image forming apparatus 1 will be described.

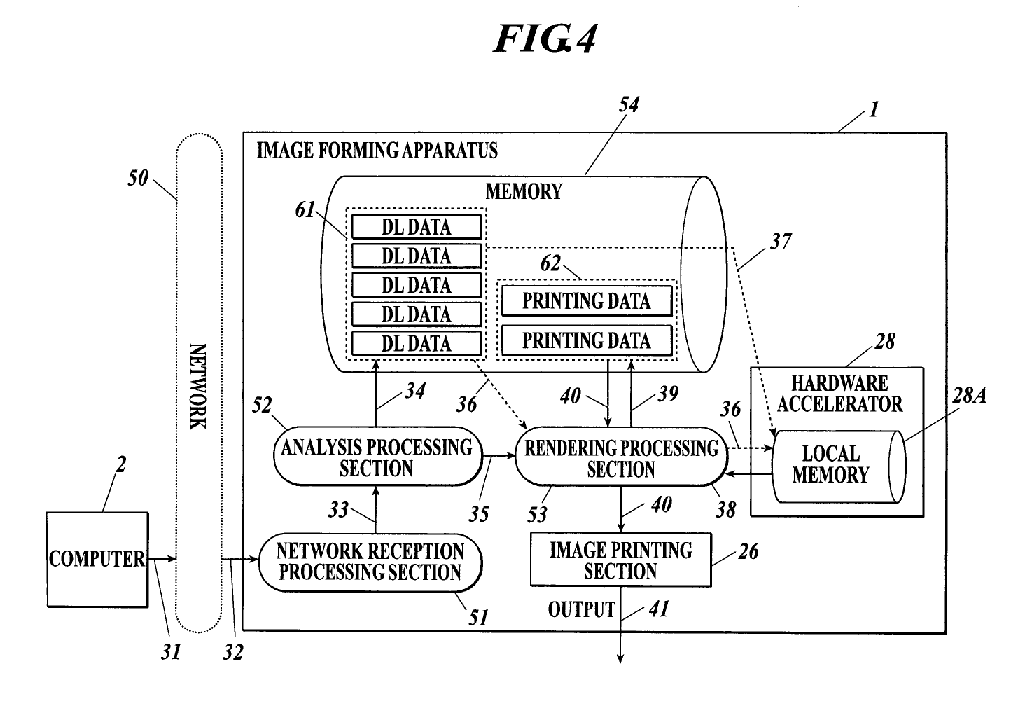

FIG. 4 is a functional block diagram showing an example of the process and function of image processing by the image forming apparatus 1.

First, a print job is transmitted from one of the computers 2 (31 in FIG. 4).

The print job is transferred through a network 50, and is received by a network reception processing section 51 of the image forming apparatus 1 (32 in FIG. 4). The network 50 is constructed by the communication connection between the computer 2 and the image forming apparatus 1 by the line 3. The network reception processing section 51 is a function performed by the communication device 27 in the image forming apparatus 1.

The print job, received by the network reception processing section 51, is input to an analysis processing section 52 (33 in FIG. 4), and is subjected to analysis processing by the analysis processing section 52. In the analysis processing, intermediate language data (such as DL data 61 in the present embodiment) is generated on the basis of a page description language included in the print job (hereinafter the page description language will be referred to as “PDL”). The analysis processing section 52 functions by reading a program, data, and the like from the ROM 23 or the storage device 24, thereby executes and processes the read program, data, and the like, so that the CPU 21 may execute the analysis processing.

The analysis processing section 52 stores the DL data 61 generated by the analysis processing in a memory 54 (34 in FIG. 4). The memory 54 in the present embodiment indicates the storage region of the RAM 22.

When the DL data 61 corresponding to the print content for one page is stored in the memory 54, the process shifts from the processing by the analysis processing section 52 to the processing by a rendering processing section 53 (35 in FIG. 4). The rendering processing section 53 performs rasterization processing on the basis of the DL data 61. The rendering processing section 53 functions by reading a program, data, and the like from the ROM 23 or the storage device 24, thereby executes and processes the read program, data, and the like, so that the CPU 21 may execute the rasterization processing. In addition, the print content for one page indicates, for example, the print content for a sheet of paper with a predetermined size (for example, A4).

In the rasterization processing, printing data 62 is generated on the basis of the DL data 61. To put it concretely, in the rasterization processing, the rendering processing of an object based on the DL data 61 is performed for the rendering region of a predetermined range, and thereby the printing data 62 is generated. The printing data 62 may be bitmap data for printing, which enables the image printing section 26 to perform print output without requiring further working and processing, or may be compressed bitmap data generated by compressing the bitmap data.

In the present embodiment, the rendering processing based on the DL data 61 is performed by the hardware accelerator 28. In addition, the rendering region of the predetermined range indicates, for example, a rendering region for one band given when a sheet of paper with a predetermined size (for example, A4) is partitioned by the plurality of band units.

In the rasterization processing, the rendering processing section 53 obtains the memory address of the DL data 61 which is the object of the rasterization processing to input the obtained memory address to the hardware accelerator 28 (36 in FIG. 4). The hardware accelerator 28 reads the DL data 61 on the basis of the input memory address (37 in FIG. 4), and performs rendering processing on the basis of the read DL data 61. The data reflecting the rendering processing result is input from the hardware accelerator 28 to the rendering processing section 53 (38 in FIG. 4). The rendering processing section 53 stores the data input from the hardware accelerator 28 to the memory 54, thereby generates the printing data 62 (39 in FIG. 4).

The printing data 62 stored in the memory 54 is input to the image printing section 26 (40 in FIG. 4) to be printed and output (41 in FIG. 4). When the printing and outputting of the printing data 62 end, the printing data 62 and the DL data 61 corresponding to the printed and output content are deleted from the memory 54.

When the print content of the print job ranges over a plurality of pages, the processing on and after the analysis processing is repeated according to the number of pages.

As discussed above, the CPU 21 of the image forming apparatus 1 reads the program, data, and the like corresponding to the processing content from the ROM 23 or the storage device 24, thereby executes and process the read program, data, and the like, and so as to function as the analysis processing section 52 and the rendering processing section 53. That is to say, the CPU 21; the RAM 22 and the ROM 23; the storage device 24; or the RAM 22 and the ROM 23, and the storage device 24 altogether, function as the image processing device in cooperation.

In addition, FIG. 4 and the flow of the image processing described above, are shown as an outline, and actual implementation of the present invention may be different from what is described above. For example, in a case where the printing ranges over a plurality of pages, the processing on and after the rasterization processing for a certain page, and the analysis processing for the pages on and after the certain page may be performed in parallel.

Next, the rendering processing by the hardware accelerator 28 will be described.

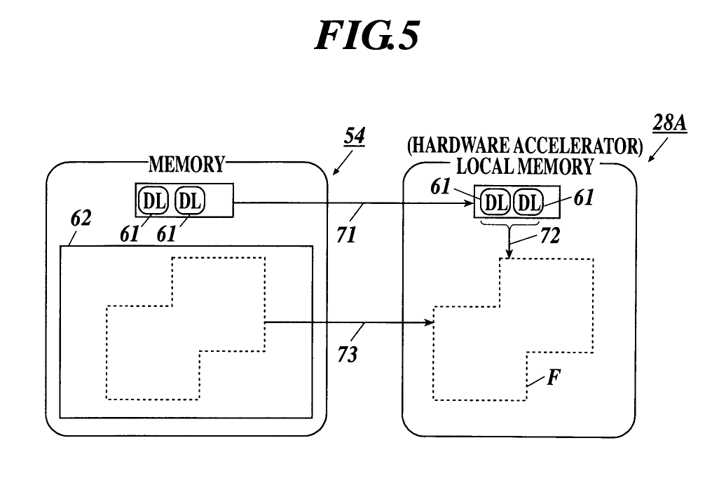

FIGS. 5 to 7 are conceptual explanatory views showing the mechanism of the rendering processing by the hardware accelerator 28.

FIG. 5 is a conceptual explanatory view showing the processing performed by the hardware accelerator 28 to copy the part corresponding to a rendering region F in the DL data 61 and the printing data 62 from the memory 54 to the local memory 28A.

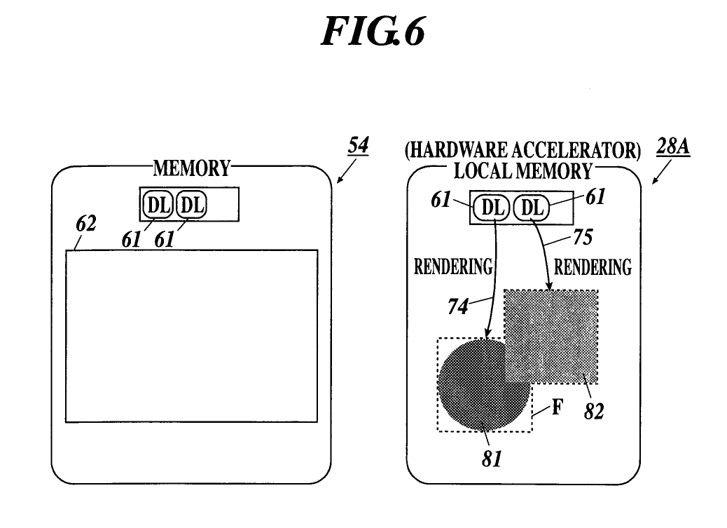

FIG. 6 is a conceptual explanatory view showing the processing performed by the hardware accelerator 28 to render objects 81 and 82 based on the DL data 61.

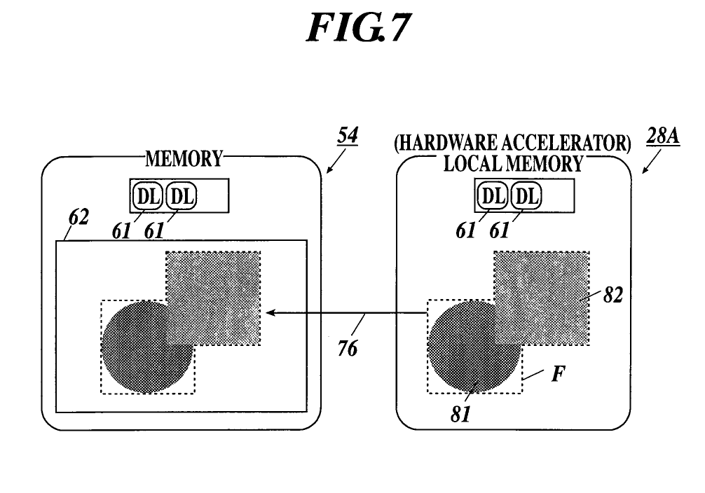

FIG. 7 is a conceptual explanatory view showing the processing of the reflection of the data of the rendering region F output from the hardware accelerator 28 to the printing data 62 in the memory 54.

The description of the rendering processing section 53 is omitted in FIGS. 5-7. The DL data 61 is described as “DL” in FIGS. 5-7.

The hardware accelerator 28 reads the DL data 61 on the basis of the memory address input from the rendering processing section 53, and copies the read DL data 61 from the memory 54 to the local memory 28A (71 in FIG. 5).

The hardware accelerator 28 obtains the rendering region (for example, the rendering region F shown in FIG. 5) for rendering the object of each DL data on the basis of the DL data 61 copied to the local memory 28A (72 in FIG. 5). Subsequently, the hardware accelerator 28 copies the part corresponding to the obtained rendering region F in the rendering regions stored in the memory 54 (73 in FIG. 5).

In the rasterization processing, the rendering processing section 53 previously stores the printing data 62 corresponding to the rendering region of a predetermined range (for example, for one band) in the memory 54 and manages the stored printing data 62. When the hardware accelerator 28 obtains the rendering region on the basis of the DL data 61, the hardware accelerator 28 copies the part of the printing data 62 corresponding to the rendering region among the printing data 62 stored and managed by the memory 54.

The rendering region F in FIG. 5 is shown merely as an example. In the processing for obtaining the rendering region on the basis of the read DL data 61, the processing of determining whether to process a plurality of rendering regions as one rendering region or not is undergone as the processing of obtaining the optimum rendering region for making the required data transfer quantity between the memory 54 and the local memory 28A be minimum. The details of the processing will be described later.

After the copying of the rendering region, the hardware accelerator 28 renders the objects (for example, the objects 81 and 82 in FIG. 6 or the like) based on the DL data 61 in the copied rendering region as shown in FIG. 6 (74 and 75 in FIG. 6).

After the rendering of the objects, the hardware accelerator 28 outputs the data in the rendering region to which rendering has been completed as shown in FIG. 7. The output data of the rendering region F is input to the rendering processing section 53, and is reflected to the printing data 62 in the memory 54 by the rendering processing section 53 (76 in FIG. 7).

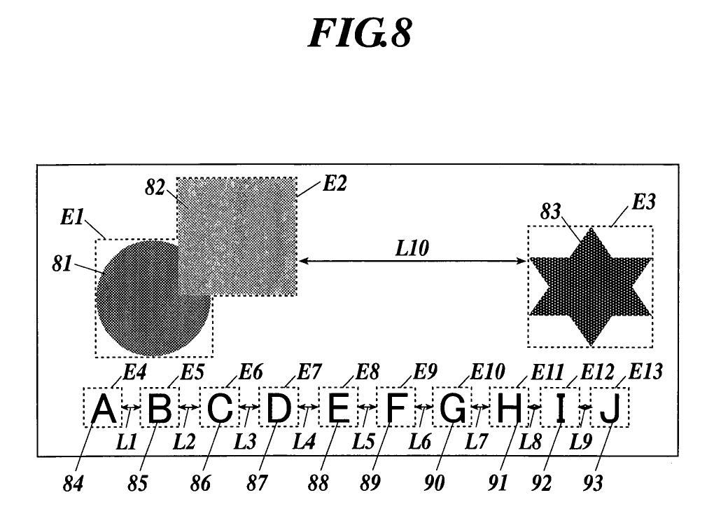

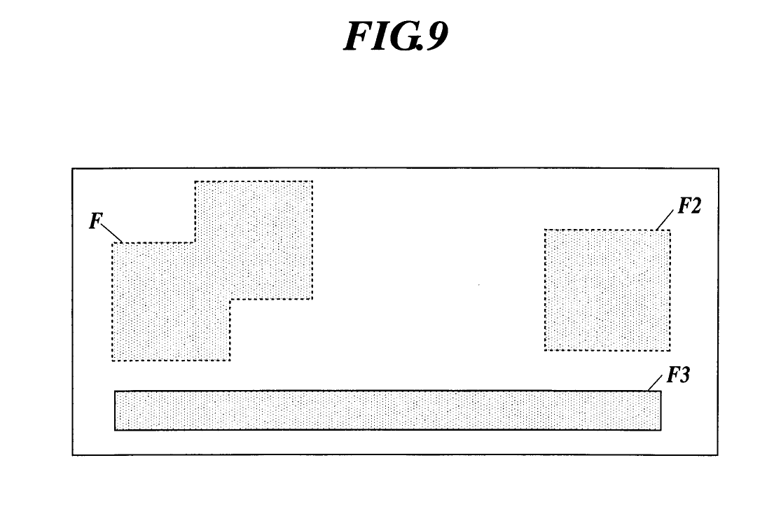

Next, the details of the processing in obtaining rendering regions on the basis of the read DL data will be described with reference to FIG. 8 and FIG. 9.

FIG. 8 is an explanatory view showing an example of the rendering content for one band.

FIG. 9 is an explanatory view showing an example of the rendering regions obtained on the basis of the DL data 61 showing the rendering content shown in FIG. 8.

A band is configured by arranging a plurality of rows (lines) of pixels along one predetermined direction and by combining them. In the present embodiment, the rendering content for one band is configured by longitudinally arranging a plurality of lines extending along the lateral direction in the rendering content shown in FIGS. 8 and 9 and by combining them in the longitudinal direction.

The hardware accelerator 28, first, obtains the rendering regions corresponding to the objects configuring the rendering content. For example, the hardware accelerator 28 obtains rectangular regions (for example, rendering regions E1-E13 shown in FIG. 8) of minimum requisite ranges for including or enclosing each of objects 81-93 shown in FIG. 8. Each object is rendered on the basis of the individual DL data 61.

When there are a predetermined number (hereinafter referred to as “predetermined number N”) or more of rendering regions on the same line, the hardware accelerator 28 determines whether to individually handle two adjacent rendering regions or not on the basis of the correlation of the adjacent rendering regions. When the two adjacent rendering regions are not handled individually, the hardware accelerator 28 performs the integration of the two rendering regions or produces a comprehensive (or enclosing) rendering region comprehending (or enclosing) the two rendering regions.

In the present embodiment, when there are two or more objects on the same line, whether to individually handle the two adjacent objects or not is determined on the basis of the existence of the two split rendering regions adjacent on the same line, and of the distance between split plurality of rendering regions.

The hardware accelerator 28 integrates a plurality of rendering regions a part or the whole of which overlaps with each other.

For example, a rendering region E1 of an object 81 and a rendering region E2 of an object 82 shown in FIG. 8 are arranged in such a way that parts of the respective regions E1 and E2 overlap with each other. The hardware accelerator 28 integrates such rendering regions apart or the whole of which overlaps with each other. As a result, one comprehensive rendering region including the rendering regions of a plurality of objects, such as the rendering region F shown in FIG. 9, is produced.

Hereby, the processing of overlapping parts can collectively be performed in comparison with the case of individually processing the overlapping rendering regions, and consequently the data transfer between the memory 54 and the local memory 28A can be improved in efficiency. For example, the hardware accelerator 28 copies the parts corresponding to the rendering regions of the printing data stored and managed by the memory 54. At this time, when overlapping rendering regions are individually processed, the overlapping part is led to be copied two or more times. Alternatively, by integrating a plurality of rendering regions a part or the whole of which overlaps with each other, it becomes unnecessary to copy the overlapping part a plurality of times.

When a distance between a plurality of split rendering regions is equal to or less than a predetermined distance (hereinafter referred to a “predetermined distance L”), the hardware accelerator 28 produces a new rendering region comprehending the plurality of split rendering regions.

For example, the objects 84-93 shown in FIG. 8 respectively have the individual rendering regions E4-E13, each split from the rendering regions of the other objects. In this case, all the distances (distances L1-L9 in FIG. 8) between the adjacent rendering regions of the objects 84-93 are respectively equal to or less than the predetermined distance L. The hardware accelerator 28 produces a new rendering region comprehending the plurality of rendering regions, in which the distance between the two adjacent rendering regions is equal to or less than the predetermined distance L. As a result, one comprehensive rendering region including the plurality of objects, such as a rendering region F3 shown in FIG. 9 is produced.

The data transfer between the memory 54 and the local memory 28A can hereby be made to be more efficient in comparison with the case of individually processing the plurality of rendering regions comprehended in the comprehensive rendering region.

When the plurality of rendering regions comprehended in a new comprehensive rendering region is individually processed, the processing of copying the part corresponding to the rendering region of the printing data 62, stored and managed in the memory 54; the processing of writing the rendering regions for which the rendering processing has been completed back from the local memory 28A to the memory 54, and the like are led to be performed for the respective rendering regions. At this time, the total overheads caused by individual copy instructions and write-back instructions become massive, and makes the accumulation of the processing time of the overheads be enormous, hence the time required for data transfer may take long. On the other hand, by using a comprehensive rendering region comprehending a plurality of rendering regions as a single rendering processing unit, the overheads caused by individual copy instructions and write-back instructions can be retrenched by a large margin. That is to say, in a case where the data transfer time including the processing time increased by the overheads caused by the individual copy instructions and write-back instructions becomes larger than the time necessary for the transfer of the data quantity increased by including the range irrelevant to the rendering processing, wherein the range is included between individual rendering regions comprehended into the comprehensive rendering region, the data transfer quantity between the memory 54 and the local memory 28A can be reduced by producing the comprehensive rendering region comprehending a plurality of rendering regions.

The predetermined distance L is preferably set within a range such that the data quantity of the range irrelevant to rendering processing included between the individual rendering regions comprehended in the comprehensive rendering region is to be smaller than the data transfer quantity owing to the overheads caused by the individual copy instructions and write-back instructions.

On the other hand, the rendering region E2 of the object 82 and the rendering region E3 of the object 83 shown in FIG. 8 are split and the distance L10 between the rendering regions E2 and E3 exceeds the predetermined distance L. The hardware accelerator 28 processes such a plurality of adjacent rendering regions, the distance between which exceeds the predetermined distance L, as individual rendering regions. As a result, a plurality of rendering regions is produced on the same line as shown as the rendering regions F and F2 in FIG. 9.

In the present embodiment, when there are three or more split rendering regions, first, whether the rendering regions are made to be a single comprehensive rendering region or made to be individual rendering regions, is determined on the basis of the distance between a rendering region located in the leftmost position on a line and a rendering region adjacent to the leftmost rendering region. Subsequently, whether the rendering regions are made to be a single comprehensive rendering region or made to be individual rendering regions is determined on the basis of the distance between the rendering region adjacent to that located in the leftmost position on the line and the rendering region adjacent to the second leftmost rendering region. Then, similar processing is repeated until whether the rendering region located in the rightmost position on the line is made to be a comprehensive rendering region or made to be an individual rendering region is determined.

When two split rendering regions are processed as one comprehensive rendering region, a region ranging from the left end (hereinafter referred to as “left point”) on a line of the rendering region located on the left side to the right end (hereinafter referred to as “right point”) on the line of the rendering region located on the right side is set as a new comprehensive rendering region.

When three or more split rendering regions are processed as one comprehensive rendering region, first, the processing of setting the rendering region located on the leftmost side on aline and a rendering region adjacent to the leftmost rendering region as one comprehensive rendering region is performed. After that, the processing of setting the rendering region produced by integrating (i) the rendering region located on the leftmost side on the line and the rendering region adjacent to the leftmost rendering region, and (ii) the rendering region adjacent to the integrated rendering region as one comprehensive rendering region is performed. Then, similar processing is repeated until the rendering region located on the rightmost side on the line among the rendering regions processed as one comprehensive rendering region is integrated.

Any numerical value and unit may be set as the predetermined distance L as long as the numerical value and the unit can be a standard of the distance between rendering regions. For example, a predetermined number of pixels, a rate to the pixel number on a line in the lengthwise direction (width), and the like can be given as the predetermined distance L. In the present embodiment, a predetermined number of pixels (for example, 50 [pixels]) is used as the predetermined distance L.

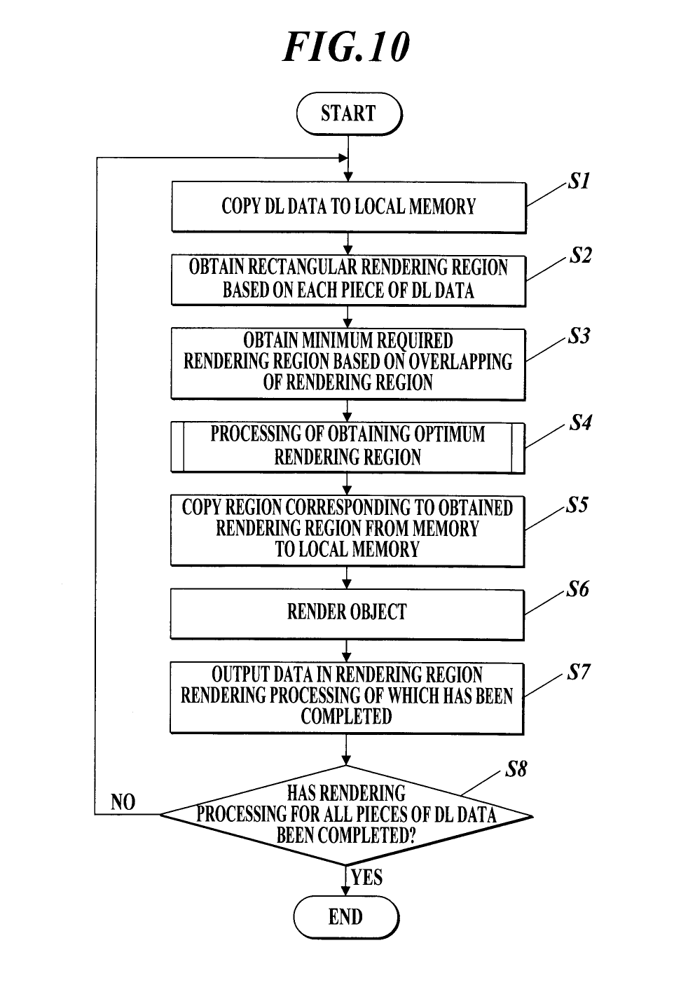

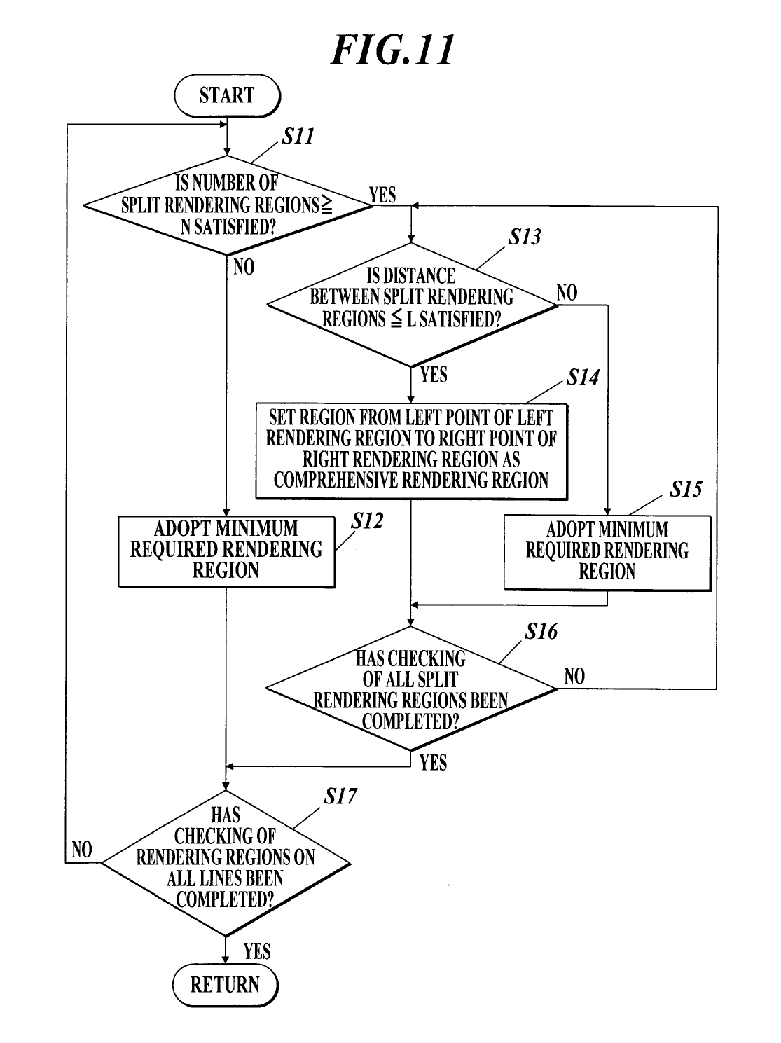

Next, the flow of the processing by the hardware accelerator 28 in rasterization processing will be described with reference to the flow charts of FIGS. 10 and 11.

FIG. 10 is a flow chart showing the flow of the processing in the rasterization processing by the hardware accelerator 28.

First, the hardware accelerator 28 copies the DL data 61 to the local memory 28A on the basis of memory addresses input from the rendering processing section 53 (Step S1). Next, the hardware accelerator 28 obtains rectangular rendering regions for rendering the objects based on the respective pieces of DL data 61 for all pieces of DL data 61 copied to the local memory 28A at Step S1 (Step S2).

Next, the hardware accelerator 28 obtains minimum requisite rendering regions on the basis of the overlapping of the rectangular rendering regions obtained at Step S2 (Step S3).

At Step S3, the hardware accelerator 28 performs the processing of obtaining the minimum requisite rendering regions (for example, the rendering region F shown in FIG. 9), including overlapping rendering regions, when the rendering regions of a plurality of objects overlap with each other, as in the case of, for example, the rendering region E1 of the object 81 and the rendering region E2 of the object 82 shown in FIG. 8.

Next, the hardware accelerator 28 performs the processing of obtaining the optimum rendering regions (Step S4).

FIG. 11 is a flow chart showing the flow of the processing of obtaining the optimum rendering regions, shown at Step S4 in FIG. 10.

First, the hardware accelerator 28 judges whether there is a predetermined number N of split rendering regions or more on a line of a processing object or not (Step S11). In the present embodiment, the predetermined number N is set to two. The predetermined number N is not limited to two, and may alternatively be set to an arbitrary value.

When the predetermined number N of split rendering regions or more does not exist on the line at Step S11 (Step S11: NO), the hardware accelerator 28 adopts the minimum requisite rendering regions obtained at or before Step S3 of FIG. 10 (Step S12).

When the predetermined number N of split rendering regions or more exists on the line at Step S11 (Step S11: YES), the hardware accelerator 28 judges whether each of the distances between adjacent rendering regions is equal to or less than the predetermined distance L or not (Step S13). When the distance between the adjacent rendering regions is equal to or less than the predetermined distance L or less (Step S13: YES), the hardware accelerator 28 sets the region ranging from the left point of the rendering region on the left side on the line to the right point of the rendering region on the right side on the line among the adjacent rendering regions as a new comprehensive rendering region (Step S14).

When the distance between the adjacent rendering regions is more than the predetermined distance L at Step S13 (Step S13: NO), the hardware accelerator 28 adopts the minimum requisite rendering regions obtained at or before Step S3 of FIG. 10 for the respective adjacent rendering regions (Step S15).

After the processing at Step S14 or Step S15, the hardware accelerator 28 judges whether all distances between split rendering regions on the line of the processing objects have been checked or not (Step S16). When all the distances between the split rendering regions have not yet been checked (Step S16: NO), the processing returns to that at Step S13, and the hardware accelerator 28 performs the judgment for the unchecked distances between the rendering regions.

After the processing at Step S12, or when the hardware accelerator 28 judges that all the distances between the split rendering regions on the line of the processing objects have been checked at Step S16 (Step S16: YES), the hardware accelerator 28 judges whether the checking of all the rendering regions on all the lines configuring one band have been completed or not on the basis of the existence of the split rendering regions and the distances between the split rendering regions (Step S17). When the checking of the rendering regions has not yet been completed (Step S17: NO), the processing returns to that at Step S11, and the hardware accelerator 28 performs the processing to the un-processed lines. When the checking of the rendering regions has been completed (Step S17: YES), the hardware accelerator 28 ends the processing of obtaining the optimum rendering regions.

After Step S4 of FIG. 10, namely, after the processing of obtaining the optimum rendering regions shown in FIG. 11 has been completed, the hardware accelerator 28 copies the parts corresponding to the rendering regions obtained by the processing up to Step S4, among the rendering regions stored in the memory 54, from the memory 54 to the local memory 28A (Step S5). Next, the hardware accelerator 28 renders the objects based on the DL data 61 in the rendering regions copied by the processing at Step S5 (Step S6). Next, the hardware accelerator 28 outputs the data of the rendering regions in which the rendering processing at Step S6 has been completed (Step S7).

After the processing at Step S7, the hardware accelerator 28 judges whether the rendering processing of all of the DL data 61 corresponding to the memory addresses input from the rendering processing section 53 has been completed or not (Step S8). When the rendering processing has not yet been completed for all of the DL data 61 corresponding to the memory addresses input from the rendering processing section 53 (Step S8: NO), the processing returns to that at Step S1, and the hardware accelerator 28 performs the rendering processing for the DL data 61, the rendering processing of which has not been completed.

When the hardware accelerator 28 judges at Step S8 that the rendering processing has been completed for all the DL data 61 corresponding to the memory addresses input from the rendering processing section 53 (Step S8: YES), the hardware accelerator 28 ends the processing.

According to the present embodiment, the hardware accelerator 28 generates a comprehensive rendering region comprehending a plurality of rendering regions on the basis of the correlation of the rendering regions. Namely, the hardware accelerator 28 generates the comprehensive rendering region comprehending the plurality of rendering regions, when the data transfer quantity between the memory 54 and the local memory 28A can be reduced by the generation of the comprehensive rendering region comprehending the plurality of rendering regions. Hereby, the data transfer quantity between the memory 54 and the local memory 28A can be reduced, and the data transfer time required at the time of the rendering processing by the hardware accelerator 28 can be shortened. The rendering processing of the hardware accelerator 28 can be speeded up in comparison with the conventional method. Hence, it is possible to realize image processing capable of coping with the reduction of cost by adopting a hardware accelerator and the speeding-up of the rendering processing by the hardware accelerator.

Furthermore, the hardware accelerator 28 integrates a plurality of rendering regions a part or the whole of which overlaps with each other. Hereby, the processing of the overlapping part can collectively be performed thereby the data transfer between the memory 54 and the local memory 28A can be improved in efficiency, in comparison with the case of individually processing the overlapping rendering regions. Hereby, the data transfer time of rendering processing by the hardware accelerator 28 can be more shortened, and the speeding-up of the rendering processing by the hardware accelerator 28 can be realized.

Furthermore, the hardware accelerator 28 generates a comprehensive rendering region on the basis of the existence of a split plurality of rendering regions. Hereby, the data transfer between the memory 54 and the local memory 28A can be improved in efficiency.

For example, when a plurality of rendering region is not split, that is to say, when the rendering regions do not overlap with each other or the rendering regions are continuous, the hardware accelerator 28 makes the plurality of rendering regions be a comprehensive rendering region comprehending them in order to collectively process the plurality of rendering regions, and thereby the hardware accelerator 28 can reduce the overheads caused by the copy instructions and write-back instructions of the individual rendering regions.

Furthermore, the hardware accelerator 28 produces a comprehensive rendering region on the basis of the distance between a plurality of split rendering regions. Hereby, the hardware accelerator 28 can make the data transfer between the memory 54 and the local memory 28A be more efficient.

For example, when a plurality of rendering regions is comprehended to a comprehensive rendering region notwithstanding the distance between the plurality of rendering regions being greatly separated, unnecessary rendering regions located between the plurality of rendering regions are also obliged to be stored in the local memory 28A. Accordingly, in such a case, the hardware accelerator 28 can make the required storage capacity for the local memory 28A be minimum, by processing the plurality of rendering regions as individual rendering regions.

Furthermore, the hardware accelerator 28 produces a comprehensive rendering region comprehending a plurality of rendering regions among which the distance of adjacent rendering regions is equal to or less than the predetermined distance L. When the data transfer time including the processing time increased by the overheads caused by individual copy instructions and write-back instructions is longer than the time required to transfer the data containing a range irrelevant to the rendering processing included between individual rendering regions to be comprehended in a new rendering region, the hardware accelerator 28 can reduce the data transfer quantity between the memory 54 and the local memory 28A by producing the comprehensive rendering region comprehending the plurality of rendering regions. Hereby, the hardware accelerator 28 can make the data transfer between the memory 54 and the local memory 28A be more efficient in comparison with the case of individually processing the plurality of rendering regions comprehended in the comprehensive rendering region. Thus, the data transfer time of the rendering processing by the hardware accelerator 28 can be more shortened, and the speeding-up of the rendering processing by the hardware accelerator 28 can be realized.

Furthermore, the processing pertaining to the production of a comprehensive rendering region is performed by the hardware accelerator 28. Hereby, the load of the processing for reducing the data transfer quantity between the memory 54 and the local memory 28A is not applied to the CPU 21. Hereby, the effect of reducing the load of the CPU 21 by introducing the hardware accelerator 28 may be larger.

Furthermore, because the rendering processing by the hardware accelerator 28 is performed by the band, namely, by the plurality of lines, a larger rendering region can be processed at the same time in comparison with the case of performing rendering processing by the line. Thereby the increase of the data transfer quantity by the overheads caused by individual copy instructions and write-back instructions may be reduced, in comparison with the case of performing rendering processing by the small rendering region by the line. Hence, the data transfer time caused by rendering processing by the hardware accelerator 28 can be more shortened, and the speeding-up of the rendering processing by the hardware accelerator can be realized.

In addition, the embodiment of the present invention disclosed in this description should be regarded as an example in all respects thereof and as being not restrictive. The scope of the present invention is shown not by the above description but by the claims, and all modifications equivalent to the claims and within the scope of the claims are intended to be included in the scope of the present invention.

For example, in the embodiment described above, the CPU 21 included in the configuration of the image forming apparatus 1 reads software from the ROM 23 or the storage device 24, to execute and process the read software, thereby functions as an image processing device. However, an independent image processing apparatus may alternatively be provided separately from the image forming apparatus 1.

Although in the embodiment described above, printing data is generated based on DL data by the band, namely by the plurality of lines, the generation of the printing data may also be performed by the line.

When rendering processing is performed by the line, the required storage capacity of the local memory 28A is only to be the capacity sufficient for copying and storing the DL data 61 for the objects existing on one line and rendering regions for one line. Consequently, the required storage capacity can be smaller by a large margin in comparison with the case of performing rendering processing by the band. Hence, in case of performing rendering processing by the line, the storage capacity of the local memory 28A may be smaller than that in the case of performing rendering processing by the band, and the cost of the hardware accelerator 28 can be further reduced.

The production processing of a rendering region comprehending a plurality of rendering regions may be performed by the control section (for example, the CPU 21 in the embodiment described above) of an image processing device in place of a hardware accelerator, or the processing pertaining to the determining of a rendering region may be performed by the cooperation of a hardware accelerator and a control section.

The memory is not limited to the storage region of a RAM. For example, the storage region of a storage device may be handled as a virtual memory, and the virtual memory may be used as the memory.

According to an aspect of the preferred embodiment of the present invention, provided is an image processing device to generate printing data based on intermediate language data, the image processing device comprising:

a memory to store the intermediate language data and the printing data;

a hardware accelerator to perform rendering processing to generate the printing data from the intermediate language data read from the memory;

and

a control section to input a memory address of the intermediate language data stored in the memory to the hardware accelerator,

wherein at least one of the hardware accelerator and the control section obtains a plurality of rendering regions corresponding to ranges to which the rendering processing is performed based on the intermediate language data, and produces a comprehensive rendering region comprehending the plurality of rendering regions based on a correlation between the plurality of rendering regions,

and wherein the hardware accelerator generates the printing data corresponding to the comprehensive rendering region to transfer the generated printing data to the memory.

According to the present embodiment, the hardware accelerator 28 generates a comprehensive rendering region comprehending a plurality of rendering regions on the basis of the correlation of the rendering regions. Namely, the hardware accelerator 28 generates the comprehensive rendering region comprehending the plurality of rendering regions, when the data transfer quantity between the memory 54 and the local memory 28A can be reduced by the generation of the comprehensive rendering region comprehending the plurality of rendering regions. Hereby, the data transfer quantity between the memory 54 and the local memory 28A can be reduced, and the data transfer time required at the time of the rendering processing by the hardware accelerator 28 can be shortened. The rendering processing of the hardware accelerator 28 can be speeded up in comparison with the conventional method. Hence, it is possible to realize image processing capable of coping with the reduction of cost by adopting a hardware accelerator and the speeding-up of the rendering processing by the hardware accelerator.

Preferably, at least one of the hardware accelerator and the control section integrates the plurality of rendering regions, a part or a whole of which overlaps with each other.

Furthermore, the hardware accelerator 28 integrates a plurality of rendering regions a part or the whole of which overlaps with each other. Hereby, the processing of the overlapping part can collectively be performed thereby the data transfer between the memory 54 and the local memory 28A can be improved in efficiency, in comparison with the case of individually processing the overlapping rendering regions. Hereby, the data transfer time of rendering processing by the hardware accelerator 28 can be more shortened, and the speeding-up of the rendering processing by the hardware accelerator 28 can be realized.

Preferably, at least one of the hardware accelerator and the control section produces the comprehensive rendering region based on an existence of a split between the plurality of rendering regions.

Furthermore, the hardware accelerator 28 generates a comprehensive rendering region on the basis of the existence of a split plurality of rendering regions. Hereby, the data transfer between the memory 54 and the local memory 28A can be improved in efficiency.

For example, when a plurality of rendering region is not split, that is to say, when the rendering regions do not overlap with each other or the rendering regions are continuous, the hardware accelerator 28 makes the plurality of rendering regions be a comprehensive rendering region comprehending them in order to collectively process the plurality of rendering regions, and thereby the hardware accelerator 28 can reduce the overheads caused by the copy instructions and write-back instructions of the individual rendering regions.

Preferably, at least one of the hardware accelerator and the control section produces the comprehensive rendering region based on a distance between the plurality of split rendering regions.

Furthermore, the hardware accelerator 28 produces a comprehensive rendering region on the basis of the distance between a plurality of split rendering regions. Hereby, the hardware accelerator 28 can make the data transfer between the memory 54 and the local memory 28A be more efficient.

For example, when a plurality of rendering regions is comprehended to a comprehensive rendering region notwithstanding the distance between the plurality of rendering regions being greatly separated, unnecessary rendering regions located between the plurality of rendering regions are also obliged to be stored in the local memory 28A. Accordingly, in such a case, the hardware accelerator 28 can make the required storage capacity for the local memory 28A be minimum, by processing the plurality of rendering regions as individual rendering regions.

Preferably, at least one of the hardware accelerator and the control section produces the comprehensive rendering region comprehending the plurality of split rendering regions, when the distance between the plurality of split rendering regions is equal to or less than a predetermined distance.

Furthermore, the hardware accelerator 28 produces a comprehensive rendering region comprehending a plurality of rendering regions among which the distance of adjacent rendering regions is equal to or less than the predetermined distance L. When the data transfer time including the processing time increased by the overheads caused by individual copy instructions and write-back instructions is longer than the time required to transfer the data containing a range irrelevant to the rendering processing included between individual rendering regions to be comprehended in a new rendering region, the hardware accelerator 28 can reduce the data transfer quantity between the memory 54 and the local memory 28A by producing the comprehensive rendering region comprehending the plurality of rendering regions. Hereby, the hardware accelerator 28 can make the data transfer between the memory 54 and the local memory 28A be more efficient in comparison with the case of individually processing the plurality of rendering regions comprehended in the comprehensive rendering region. Thus, the data transfer time of the rendering processing by the hardware accelerator 28 can be more shortened, and the speeding-up of the rendering processing by the hardware accelerator 28 can be realized.

Preferably, only the hardware accelerator performs processing of obtaining the rendering regions showing the ranges to which the rendering processing is performed based on the intermediate language data, and producing the comprehensive rendering region based on the correlation between the plurality of rendering regions.

Furthermore, the processing pertaining to the production of a comprehensive rendering region is performed by the hardware accelerator 28. Hereby, the load of the processing for reducing the data transfer quantity between the memory 54 and the local memory 28A is not applied to the CPU 21. Hereby, the effect of reducing the load of the CPU 21 by introducing the hardware accelerator 28 may be larger.

Preferably, the rendering regions are respectively a rectangular region including a minimum requisite range to perform the rendering processing.

Hereby, the rendering regions including the minimum requisite range to perform the rendering processing may be obtained by the rectangular region.

Preferably, the rendering processing by the hardware accelerator is performed by a plurality of lines.

Furthermore, because the rendering processing by the hardware accelerator 28 is performed by the band, namely, by the plurality of lines, a larger rendering region can be processed at the same time in comparison with the case of performing rendering processing by the line. Thereby the increase of the data transfer quantity by the overheads caused by individual copy instructions and write-back instructions may be reduced, in comparison with the case of performing rendering processing by the small rendering region by the line. Hence, the data transfer time caused by rendering processing by the hardware accelerator 28 can be more shortened, and the speeding-up of the rendering processing by the hardware accelerator can be realized.

Preferably, the rendering processing by the hardware accelerator is performed by each line.

When rendering processing is performed by the line, the required storage capacity of the local memory 28A is only to be the capacity sufficient for copying and storing the DL data 61 for the objects existing on one line and rendering regions for one line. Consequently, the required storage capacity can be smaller by a large margin in comparison with the case of performing rendering processing by the band. Hence, in case of performing rendering processing by the line, the storage capacity of the local memory 28A may be smaller than that in the case of performing rendering processing by the band, and the cost of the hardware accelerator 28 can be further reduced.

What is claimed is:

1. An image processing device to generate printing data based on intermediate language data, the image processing device comprising:
a memory to store the intermediate language data and the printing data;
a hardware accelerator to perform rendering processing to generate the printing data from the intermediate language data read from the memory; and
a control section to input a memory address of the intermediate language data stored in the memory to the hardware accelerator,
wherein at least one of the hardware accelerator and the control section obtains a plurality of rendering regions corresponding to ranges to which the rendering processing is performed based on the intermediate language data, and produces a comprehensive rendering region comprehending the plurality of rendering regions based on a correlation between the plurality of rendering regions,
and wherein the hardware accelerator generates the printing data corresponding to the comprehensive rendering region to transfer the generated printing data to the memory.

2. The image processing device as claimed in claim 1, wherein at least one of the hardware accelerator and the control section integrates the plurality of rendering regions, a part or a whole of which overlaps with each other.

3. The image processing device as claimed in claim 1, wherein at least one of the hardware accelerator and the control section produces the comprehensive rendering region based on an existence of a split between the plurality of rendering regions.

4. The image processing device as claimed in claim 3, wherein at least one of the hardware accelerator and the control section produces the comprehensive rendering region based on a distance between the plurality of split rendering regions.

5. The image processing device as claimed in claim 4, wherein at least one of the hardware accelerator and the control section produces the comprehensive rendering region comprehending the plurality of split rendering regions, when the distance between the plurality of split rendering regions is equal to or less than a predetermined distance.

6. The image processing device as claimed in claim 1, wherein only the hardware accelerator performs processing of obtaining the rendering regions showing the ranges to which the rendering processing is performed based on the intermediate language data, and producing the comprehensive rendering region based on the correlation between the plurality of rendering regions.

7. The image processing device as claimed in claim 1, wherein the rendering regions are respectively a rectangular region including a minimum requisite range to perform the rendering processing.

8. The image processing device as claimed in claim 1, wherein the rendering processing by the hardware accelerator is performed by a plurality of lines.

9. The image processing device as claimed in claim 1, wherein the rendering processing by the hardware accelerator is performed by each line.

10. A hardware accelerator to perform rendering processing for reading intermediate language data so as to generate printing data, based on a memory address of the intermediate language data stored in a memory provided outside of the hardware accelerator,
wherein the hardware accelerator obtains a plurality of rendering regions corresponding to ranges to which the rendering processing is performed based on the intermediate language data; produces a comprehensive rendering region comprehending the plurality of rendering regions based on a correlation between the plurality of rendering regions; and generates the printing data corresponding to the comprehensive rendering region to transfer the generated printing data to the memory.

11. The hardware accelerator as claimed in claim 10, wherein the plurality of rendering regions, a part or a whole of which overlaps with each other, are integrated.

12. The hardware accelerator as claimed in claim 10, wherein the comprehensive rendering region is produced based on an existence of a split between the plurality of rendering regions.

13. The hardware accelerator as claimed in claim 12, wherein the comprehensive rendering region is produced based on a distance between the plurality of split rendering regions.

14. The hardware accelerator as claimed in claim 13, wherein the comprehensive rendering region comprehending the plurality of split rendering regions is produced, when the distance between the plurality of split rendering regions is equal to or less than a predetermined distance.

15. The hardware accelerator as claimed in claim 10, wherein the rendering regions are respectively a rectangular region including a minimum requisite range to perform the rendering processing.

16. The hardware accelerator as claimed in claim 10, wherein the rendering processing by the hardware accelerator is performed by a plurality of lines.

17. The hardware accelerator as claimed in claim 10, wherein the rendering processing by the hardware accelerator is performed by each line.

18. An image processing method to generate printing data based on intermediate language data, comprising:
inputting a memory address of the intermediate language data to a hardware accelerator by a control section;
performing rendering processing of reading the intermediate language data to generate the printing data by the hardware accelerator; and
obtaining a plurality of rendering regions corresponding to ranges to which the rendering processing is performed based on the intermediate language data, followed by producing a comprehensive rendering region comprehending the plurality of rendering regions based on a correlation between the plurality of rendering regions, by at least one of the hardware accelerator and the control section.
